(19) United States
(12) Patent Application Publication
(10) Pub. No.: US 2024/0425672 A1
(43) Pub. Date: Dec. 26, 2024

(54) COMPOUNDING AGENT FOR RUBBER, RUBBER COMPOSITION, AND TIRE

(71) Applicant: Toyo Tire Corporation, Itami-shi (JP)

(72) Inventor: Hironori Miyazaki, Itami-shi (JP)

(73) Assignee: Toyo Tire Corporation, Itami-shi (JP)

(21) Appl. No.: 18/672,242

(22) Filed: May 23, 2024

(30) Foreign Application Priority Data
Jun. 14, 2023 (JP) 2023-097963

(51) Int. Cl. C08K 5/01; B60C 1/00; C08K 3/06; C08L 9/06

(52) U.S. Cl. CPC C08K 5/01; B60C 1/0016; B60C 1/0025; C08K 3/06; C08L 9/06; C08L 2312/02

(57) ABSTRACT

A compounding agent for rubber according to an embodiment contains an inverse vulcanizate in which a sum of a content of a carbon element and a content of a sulfur element is 89 mass % or more. A rubber composition according to an embodiment includes the compounding agent for rubber. A tire according to an embodiment is produced using the rubber composition.

### BACKGROUND OF THE INVENTION

### 1. Field of the Invention

The present invention relates to a compounding agent for rubber, a rubber composition containing the compounding agent for rubber, and a tire.

### 2. Description of Related Art

In recent years, rubber compositions used for rubber products such as tires are required to have improved fracture properties in order to improve durability.

In order to solve such a problem, JP2005-507966A describes a rubber composition containing, for example, a long chain crosslinking agent represented by H(SCH₂CH₂OCH₂CH₂S)ₙH as a rubber composition having excellent abrasion resistance. JP2019-19310A describes a rubber composition containing, for example, a sulfur-containing oligomer having repeating units represented by —(CH₂)₂O(CH₂)₂-δₓ— as a rubber composition having excellent chipping resistance (elongation at break). However, there is room for improvement in breaking strength.

### SUMMARY OF THE INVENTION

In view of the above, an object of the invention is to provide a compounding agent for rubber which can improve breaking strength.

The rubber compositions described in JP2005-507966A and JP2019-19310A do not contain an inverse vulcanizate. JP2017-517603A describes an inverse vulcanizate, but does not describe compounding the inverse vulcanizate as a vulcanizing agent in a rubber composition.

The invention includes embodiments to be described below.

[1] A compounding agent for rubber includes: an inverse vulcanizate in which a sum of a content of a carbon element and a content of a sulfur element is 89 mass % or more.

[2] The compounding agent for rubber according to [1], wherein the inverse vulcanizate contains, as a raw material, an organic compound having a topological polar surface area of 50 Å² or less and two or more carbon-carbon double bonds.

[3] The compounding agent for rubber according to [1] or [2], wherein the inverse vulcanizate contains, as a raw material, an organic compound having two or more carbon-carbon double bonds and zero or one heteroatom contained in one molecule.

[4] The compounding agent for rubber according to any one of [1] to [3], wherein the inverse vulcanizate contains, as a raw material, an organic compound having two or more carbon-carbon double bonds and an aromatic ring, and the content of the carbon element is 20 mass % or more.

[5] A rubber composition includes the compounding agent for rubber according to any one of [1] to [4].

[6] A tire is produced using the rubber composition according to [5].

According to the embodiments of the invention, the breaking strength of the rubber composition can be improved.

### DESCRIPTION OF EMBODIMENTS

Hereinafter, matters related to embodiments of the invention will be described in detail.

A compounding agent for rubber according to an embodiment contains an inverse vulcanizate in which a sum of a content of a carbon element and a content of a sulfur element is 89 mass % or more. In the present specification, the term “inverse vulcanizate” refers to a substance having a structure in which chain sulfur is crosslinked with a small amount of an organic substance, and is different from a substance in which polymer chains of an organic substance are crosslinked with a small amount of sulfur, which is obtained by normal vulcanization.

The inverse vulcanizate is obtained by reacting an organic compound having two or more carbon-carbon double bonds with sulfur. For example, as shown in the following reaction formula, cyclic sulfur is changed into linear chain sulfur by heating. Then, the linear chain sulfur and the organic compound having two or more carbon-carbon double bonds are mixed and reacted to obtain the inverse vulcanizate. This reaction includes a nucleophilic addition reaction of a sulfur radical to a double bond. A temperature condition for mixing the linear chain sulfur and the organic compound is preferably 100° C. or higher, more preferably 120° C. or higher, and still more preferably 140° C. or higher. A catalyst such as a base or a metal salt may be used as necessary.

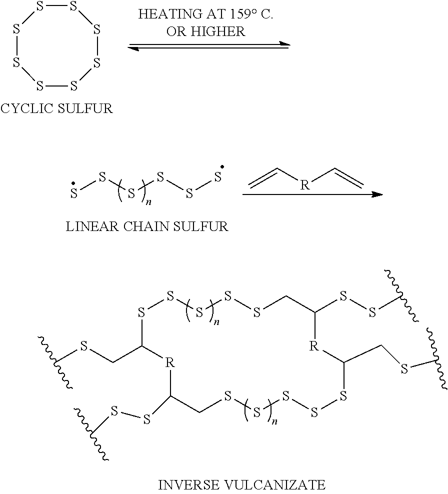

In the inverse vulcanizate, sulfur chains are split during vulcanization of the rubber composition, and a crosslinked structure containing carbon chains is bonded to polymer chains of a rubber component to form a crosslinked structure. By forming the crosslinked structure containing carbon chains as the crosslinked structure, a crosslinked chain is longer than that of a crosslinked structure composed of only sulfur, which is obtained by normal vulcanization. As a result, it is considered that flexibility and breaking strength of the rubber are improved. In addition, when the rubber composition is stored as an unvulcanized rubber composition, since the inverse vulcanizate is a polymer, it is considered that the inverse vulcanizate has lower migration properties and is less likely to bleed out as compared with sulfur.

In the embodiment, among the inverse vulcanizates, an inverse vulcanizate in which the sum of the content of the carbon element and the content of the sulfur element is 89 mass % or more is used. The electronegativity of carbon is 2.55, and the electronegativity of sulfur is 2.58. The electronegativities of both are very close. When the carbon element and the sulfur element having very close electronegativities occupy a large amount, the inverse vulcanizate has less polar separation and low polarity. It is considered that such a low-polarity inverse vulcanizate has good compatibility with a hydrophobic (that is, low-polarity) rubber and is easily dispersed in the rubber component, and thus has excellent dispersibility in the rubber composition. Therefore, it is considered that crosslinking is made uniform, stress concentration during strain deformation can be prevented, and breaking strength can be further improved.

The sum of the amount of the carbon element and the amount of the sulfur element contained in the inverse vulcanizate (a total content ratio of the carbon element and the sulfur element) is more preferably 90 mass % or more, and still more preferably 91 mass % or more. An upper limit of the sum is not particularly limited, and may be, for example, 99 mass % or less, or 98 mass % or less.

In the present specification, contents of the carbon element and the sulfur element are values measured by a combustion method using an organic elemental analyzer, and a detailed measurement method is as described in the column of Examples.

The content ratio of the carbon element in the inverse vulcanizate is preferably 10 mass % to 60 mass %, more preferably 15 mass % to 50 mass %, and still more preferably 20 mass % to 45 mass %. The content ratio of the sulfur element in the inverse vulcanizate is preferably 30 mass % to 89 mass %, more preferably 40 mass % to 84 mass %, and still more preferably 45 mass % to 79 mass %.

A mass ratio (sulfur element/carbon element) of the content ratio of the sulfur element to the carbon element in the inverse vulcanizate is not particularly limited, and is preferably 1.0 to 10, more preferably 1.0 to 5.0, and still more preferably 1.1 to 4.0.

In one embodiment, the inverse vulcanizate preferably contains, as a raw material, an organic compound having a topological polar surface area of 50 Å² or less and two or more carbon-carbon double bonds in the molecule. That is, the inverse vulcanizate is preferably synthesized by using the organic compound as a raw material, and more specifically, is preferably obtained by reacting the organic compound with sulfur. When the organic compound used as a raw material has a low topological polar surface area of 50 Å² or less and has low polarity, the compatibility with the hydrophobic rubber is further improved, and the dispersibility in the rubber composition can be improved. The topological polar surface area is more preferably 30 Å² or less, still more preferably 25 Å² or less, and may be 0 Å².

The topological polar surface area (tPSA) refers to an area of a polar part in a surface of a molecule, and is defined as a total surface sum of all polar atoms (mainly oxygen, nitrogen, and hydrogen bonded thereto). The topological polar surface area is a polarity surface area approximately calculated from only a bonding pattern (topology) of atoms in a molecule without considering a three-dimensional structure of the molecule, and is calculated by a method described in Ertl P. et al., J. Med. Chem, 43 (2000), 3714-3717. Specifically, the topological polar surface area can be calculated by commercially available molecular structural editor software, and in the present specification, a value calculated by ChemBioDraw Ultra (registered trademark) (version 13.0) provided by Revvity Signals Software is used.

In one embodiment, the inverse vulcanizate preferably contains, as a raw material, an organic compound having two or more carbon-carbon double bonds and zero or one heteroatom contained in one molecule. As described above, the organic compound used as a raw material of the inverse vulcanizate may have one heteroatom, or may have no heteroatom, that is, may be a hydrocarbon. When the number of heteroatoms is small, the organic compound has low polarity, and the dispersibility of the inverse vulcanizate in the rubber composition can be improved. More preferably, the organic compound satisfies a condition that the topological polar surface area is 50 Å² or less. Here, examples of the heteroatom include an oxygen atom, a nitrogen atom, a sulfur atom, a silicon atom, and a phosphorus atom, and preferably an oxygen atom. The oxygen atom may be contained in the molecule of the organic compound as, for example, a hydroxy group or a carbonyl group.

A boiling point of the organic compound used as the raw material of the inverse vulcanizate is not particularly limited, and is preferably 80° C. or higher, more preferably 100° C. or higher, and still more preferably 120° C. or higher. In addition, a molecular weight of the organic compound is not particularly limited, and is preferably 100 to 3000, more preferably 100 to 500, and still more preferably 100 to 300.

Specific examples of the organic compound used as a raw material of the inverse vulcanizate include acyclic monoterpene such as myrcene, citral, nerol, geraniol, geranyl nitrile, citral dimethyl acetal, geranylacetone, and linalool, cyclic monoterpene such as limonene, terpinene, terpinolene, perylaldehyde, phellandrene, dehydroxy linalool oxide, and carvone, sesquiterpene such as farnesene, farnesol, nerolidol, bisabolol, nootkatone, germacrone, caryophyllene, and cadinene, diterpene such as isophytol and geranyl-linalool, triterpene such as squalene and lanosterol, other terpenes such as solanesol, ionone, and methyl ionone, dicyclopentadiene (DCPD), diisopropenylbenzene (DIB), divinyl benzene (DVB), ethylene glycol dimethacrylate (EGDMA), 1,5,9-cyclododecatriene (CDDT), 5-vinyl-2-norbornene (VNB), 1,2,4-trivinylhexane (TVCH), tetraallyloxyethane, and 2,4,6,8-tetramethyl-2,4,6,8-tetravinylcyclotetrasiloxane, linoleic acid, and linolenic acid. These organic compounds may be used alone or in combination of two or more kinds thereof.

In one embodiment, a terpene-based compound (X) may be used as the organic compound. It is considered that an inverse vulcanizate having a terpene chemical structure is excellent in dispersibility in the rubber composition because the inverse vulcanizate has good compatibility with a rubber component. The terpene-based compound (X) is a natural compound having isoprene as a constituent unit, and is used as a concept including not only terpene that is a hydrocarbon having isoprene as a constituent unit, but also terpenoid that is a derivative having a functional group such as a carbonyl group or a hydroxy group. Specific examples of the terpene-based compound (X) having two or more carbon-carbon double bonds, having a topological polar surface area of 50 Å² or less, and having one or less heteroatom include the acyclic monoterpene, the cyclic monoterpene, the sesquiterpene, the diterpene, and other terpenes listed above. Among these, the terpene-based compound (X) is preferably at least one selected from the group consisting of limonene, farnesene, farnesol, myrcene, and squalene.

When the terpene-based compound (X) is used as the organic compound as a raw material of the inverse vulcanizate, a ratio of the terpene-based compound (X) is preferably 40 mass % to 100 mass %, more preferably 50 mass % to 100 mass %, still more preferably 70 mass % to 100 mass %, and yet still more preferably 90 mass % to 100 mass %, with respect to 100 mass % of the organic compound. A ratio of a component derived from the terpene-based compound (X) is preferably 40 mass % to 100 mass %, more preferably 50 mass % to 100 mass %, still more preferably 70 mass % to 100 mass %, and yet still more preferably 90 mass % to 100 mass %, with respect to 100 mass % of a component derived from the organic compound in the inverse vulcanizate.

In one embodiment, the inverse vulcanizate may contain, as a raw material, an organic compound (hereinafter referred to as an aromatic compound (Y)) having two or more carbon-carbon double bonds and an aromatic ring in the molecule. It is preferable that the aromatic compound (Y) further satisfies at least one of the following conditions that the topological polar surface area is 50 Å² or less and the number of heteroatoms contained in one molecule is zero or one. Here, the aromatic ring is preferably a benzene ring. Examples of the aromatic compound (Y) include diisopropenylbenzene (DIB), triisopropenylbenzene (TIB), 1-phenyl-1,3-butadiene, 1,4-diphenyl-1,3-butadiene, 1,6-diphenyl-1,3,5-hexatriene, 1,1,4,4-tetraphenyl-1,3-butadiene, 1,4-bis(2-methylstyryl)benzene, and dibenzylideneacetone. These aromatic compounds (Y) may be used alone or in combination of two or more kinds thereof.

When the inverse vulcanizate contains the aromatic compound (Y) as a raw material, the amount of the carbon element contained in the inverse vulcanizate is preferably 20 mass % or more, more preferably 25 mass % to 60 mass %, still more preferably 30 mass % to 50 mass %, and yet still more preferably 35 mass % to 45 mass %. Accordingly, the effect of improving the breaking strength can be enhanced.

When the aromatic compound (Y) is used as the organic compound as a raw material of the inverse vulcanizate, a ratio of the aromatic compound (Y) is preferably 40 mass % to 100 mass %, more preferably 50 mass % to 100 mass %, still more preferably 70 mass % to 100 mass %, and yet still more preferably 90 mass % to 100 mass %, with respect to 100 mass % of the organic compound. A ratio of a component derived from the aromatic compound (Y) is preferably 40 mass % to 100 mass %, more preferably 50 mass % to 100 mass %, still more preferably 70 mass % to 100 mass %, and yet still more preferably 90 mass % to 100 mass %, with respect to 100 mass % of a component derived from the organic compound in the inverse vulcanizate.

The organic compound used as the raw material of the inverse vulcanizate may be only one having two or more carbon-carbon double bonds, and may be used in combination with an organic compound having one carbon-carbon double bond as long as the effect is not impaired.

The inverse vulcanizate is preferably in a solid state at a normal temperature of 23° C. When the inverse vulcanizate is in a solid state, it is easy to handle the inverse vulcanizate in the case of preparing the rubber composition. Here, the term “solid state” refers to a state in which the inverse vulcanizate does not have fluidity at a normal temperature of 23° C.

A glass transition point of the inverse vulcanizate is not particularly limited, and is preferably −50° C. to 60° C., more preferably −20° C. to 50° C., still more preferably −10° C. to 45° C., and yet still more preferably 0° C. to 45° C. When the inverse vulcanizate having a glass transition point of 60° C. or lower is used, the inverse vulcanizate is melted when mixed with the rubber composition, and is easily uniformly dispersed in the rubber composition. In this regard, a melting point of sulfur used in normal vulcanization is 112.8° C., which is higher than a temperature at the time of mixing with the rubber composition. Here, the term “glass transition point” is a value measured at a temperature rise rate of 20° C./min (measurement temperature range: −100° C. to 150° C.) by a differential scanning calorimetry (DSC) method in accordance with JIS K7121:2012.

The compounding agent for rubber according to the embodiment may consist of the inverse vulcanizate, or may contain an additive generally compounded in the rubber composition together with the inverse vulcanizate. In one embodiment, the compounding agent for rubber may contain the inverse vulcanizate in an amount of 30 mass % or more, 50 mass % or more, 70 mass % or more, or 100 mass %. The compounding agent for rubber is used as a crosslinking agent (vulcanizing agent) because the inverse vulcanizate forms a crosslinked structure as described above. Therefore, in one embodiment, the compounding agent for rubber is a rubber crosslinking agent (vulcanizing agent).

The rubber composition according to the embodiment contains the compounding agent for rubber. The rubber composition preferably contains a diene rubber as a rubber component together with the compounding agent for rubber.

The diene rubber refers to a rubber having a repeating unit corresponding to a diene monomer having a conjugated double bond, and has a double bond in a polymer main chain. Specific examples of the diene rubber include a natural rubber (NR), an isoprene rubber (IR), a butadiene rubber (BR), a styrene-butadiene rubber (SBR), a nitrile rubber (NBR), a chloroprene rubber (CR), a butyl rubber (IIR), a styrene-isoprene copolymer rubber, a butadiene-isoprene copolymer rubber, and a styrene-isoprene-butadiene copolymer rubber. These diene rubbers may be used alone or in combination of two or more kinds thereof. Among these, the diene rubber is preferably at least one selected from the group consisting of NR, IR, BR, and SBR. Those obtained by modifying a chain-end or a main chain as necessary (for example, a chain-end-modified SBR) or those obtained by modification to impart desired characteristics (for example, a modified NR) are also included in the concept of the diene rubber.

A content of the compounding agent for rubber in the rubber composition, as a content of the inverse vulcanizate, is preferably 0.1 parts by mass to 20 parts by mass, more preferably 0.5 parts by mass to 15 parts by mass, still more preferably 1 part by mass to 10 parts by mass, and yet still more preferably 2 parts by mass to 8 parts by mass, with respect to 100 parts by mass of the diene rubber. In addition, a content of the inverse vulcanizate is, in terms of sulfur, preferably 0.05 parts by mass to 16 parts by mass, more preferably 0.3 parts by mass to 12 parts by mass, still more preferably 0.5 parts by mass to 8 parts by mass, and yet still more preferably 1 part by mass to 5 parts by mass, with respect to 100 parts by mass of the diene rubber.

A reinforcing filler may be compounded in the rubber composition. As the reinforcing filler, carbon black and/or silica is preferably used. That is, the reinforcing filler may be carbon black alone, silica alone, or a combination of carbon black and silica. The reinforcing filler is preferably carbon black alone or a combination of carbon black and silica. A content of the reinforcing filler is not particularly limited, and may be, for example, 10 parts by mass to 140 parts by mass, 20 parts by mass to 100 parts by mass, or 20 parts by mass to 80 parts by mass, with respect to 100 parts by mass of the diene rubber.

The carbon black is not particularly limited, and various known products can be used. When the carbon black is compounded, the content thereof may be, for example, 5 parts by mass to 100 parts by mass, or 20 parts by mass to 80 parts by mass, with respect to 100 parts by mass of the diene rubber.

The silica is also not particularly limited, and wet silica such as wet-precipitated silica or wet-gelled silica is preferably used. When the silica is compounded, the content thereof may be, for example, 5 parts by mass to 40 parts by mass, or 5 parts by mass to 30 parts by mass, with respect to 100 parts by mass of the diene rubber.

In addition to the components described above, various additives generally used in the rubber composition, such as a silane coupling agent, zinc oxide, stearic acid, an antioxidant, a wax, an oil, and a vulcanization accelerator, can be compounded in the rubber composition according to the embodiment.

In the rubber composition, sulfur may be compounded in addition to the inverse vulcanizate as the vulcanizing agent (crosslinking agent), or may not be compounded. When the inverse vulcanizate and the sulfur are used in combination, a content of the vulcanizing agent (a total amount of the inverse vulcanizate and the sulfur) is not particularly limited, and is preferably 0.1 parts by mass to 20 parts by mass, and more preferably 0.5 parts by mass to 10 parts by mass, with respect to 100 parts by mass of the diene rubber.

Examples of the vulcanization accelerator include various vulcanization accelerators such as sulfenamide-based, thiuram-based, thiazole-based, and guanidine-based vulcanization accelerators, which may be used alone or in combination of two or more kinds thereof. A content of the vulcanization accelerator is not particularly limited, and is preferably 0.1 parts by mass to 7 parts by mass, and more preferably 0.5 parts by mass to 5 parts by mass, with respect to 100 parts by mass of the diene rubber.

The rubber composition according to the embodiment can be produced by kneading according to a common method by using a mixer such as a Banbury mixer, a kneader, or a roll that is normally used. That is, for example, in a first mixing stage, additives excluding the vulcanizing agent (including the inverse vulcanizate) and the vulcanization accelerator are added to and mixed with the diene rubber. Next, in a final mixing stage, the vulcanizing agent (including the inverse vulcanizate) and the vulcanization accelerator are added to and mixed with the obtained mixture, and thus a rubber composition can be prepared.

The rubber composition thus obtained can be used for various rubber products such as a tire, a rubber vibration insulator, and a conveyor belt. When the rubber composition is used in a tire, the rubber composition can be used as a tread rubber or a side wall rubber of a pneumatic tire of various applications and various sizes, such as a passenger car tire and a large tire of a truck or a bus (heavy duty tire).

The rubber composition is molded into a predetermined shape by a common method, for example, by extrusion, and becomes a vulcanized rubber by heating and vulcanizing. When the rubber composition is used for a tire, the rubber composition is molded into a predetermined shape by extrusion or the like, and is combined with other parts to produce a green tire. Thereafter, a tire can be manufactured by vulcanization molding the green tire at, for example, 130° C. to 190° C.

### EXAMPLES

Hereinafter, Examples of the invention will be illustrated, but the invention is not limited to these Examples.

A topological polar surface area (tPSA) of an organic compound used as a raw material in the following Synthesis Examples A to His as follows.
Farnesol: 20.23 Å²
Ethylene glycol dimethacrylate: 52.6 Å²
Other organic compounds: 0 Å² (because no heteroatom is contained)

For inverse vulcanizates A to H synthesized in Synthesis Examples A to H, contents of a carbon element and a sulfur element were measured by a combustion method using an organic elemental analyzer. For the measurement, an organic elemental analyzer “vario MACRO cube” (manufactured by Elementar Japan) was used. The measurement conditions were as follows: gas: helium, oxygen; standard substance: sulfanilamide; combustion tube temperature: 1150° C.; and reduction tube temperature: 850° C.

### Synthesis Example A

To a glass container, 2.5 g of sulfur was added and stirred at 165° C. for 15 minutes. After it was confirmed that the sulfur was dissolved, 0.5 g of dicyclopentadiene and 2.0 g of (+)-limonene were added, and the mixture was further stirred at 165° C. for 30 minutes. After it was confirmed that a color of the solution was changed, the solution was poured into a silicon mold. Thereafter, the solution was heated in an oven at 140° C. for 16 hours to obtain an inverse vulcanizate A. The obtained inverse vulcanizate A was subjected to elementary analysis. As a result, a carbon content was 31 mass %, a sulfur content was 66 mass %, and a sum thereof was 96 mass %. A glass transition point of the inverse vulcanizate A was 29° C.

### Synthesis Example B

To a glass container, 4.0 g of sulfur was added and stirred at 165° C. for 15 minutes. After it was confirmed that the sulfur was dissolved, 0.5 g of dicyclopentadiene and 0.5 g of (+)-limonene were added, and the mixture was further stirred at 165° C. for 30 minutes. After it was confirmed that a color of the solution was changed, the solution was poured into a silicon mold. Thereafter, the solution was heated in an oven at 140° C. for 16 hours to obtain an inverse vulcanizate B. The obtained inverse vulcanizate B was subjected to elementary analysis. As a result, a carbon content was 22 mass %, a sulfur content was 76 mass %, and a sum thereof was 97 mass %. A glass transition point of the inverse vulcanizate B was 17° C.

### Synthesis Example C

To a glass container, 4.0 g of sulfur was added and stirred at 175° C. for 15 minutes. After it was confirmed that the sulfur was dissolved, 2.5 g of trans-β-farnesene was added, and the mixture was further stirred at 175° C. for 60 minutes. After it was confirmed that a color of the solution was changed, the solution was poured into a silicon mold. Thereafter, the solution was heated in an oven at 140° C. for 16 hours to obtain an inverse vulcanizate C. The obtained inverse vulcanizate C was subjected to elementary analysis. As a result, a carbon content was 42 mass %, a sulfur content was 50 mass %, and a sum thereof was 92 mass %. A glass transition point of the inverse vulcanizate C was 16° C.

### Synthesis Example D

To a glass container, 4.0 g of sulfur was added and stirred at 175° C. for 15 minutes. After it was confirmed that the sulfur was dissolved, 2.5 g of farnesol was added, and the mixture was further stirred at 175° C. for 60 minutes. After it was confirmed that a color of the solution was changed, the solution was poured into a silicon mold. Thereafter, the solution was heated in an oven at 140° C. for 16 hours to obtain an inverse vulcanizate D. The obtained inverse vulcanizate D was subjected to elementary analysis. As a result, a carbon content was 38 mass %, a sulfur content was 53 mass %, and a sum thereof was 91 mass %. A glass transition point of the inverse vulcanizate D was 21° C.

### Synthesis Example E

To a glass container, 2.5 g of sulfur was added and stirred at 175° C. for 15 minutes. After it was confirmed that the sulfur was dissolved, 2.5 g of myrcene was added, and the mixture was further stirred at 175° C. for 60 minutes. After it was confirmed that a color of the solution was changed, the solution was poured into a silicon mold. Thereafter, the solution was heated in an oven at 140° C. for 16 hours to obtain an inverse vulcanizate E. The obtained inverse vulcanizate E was subjected to elementary analysis. As a result, a carbon content was 39 mass %, a sulfur content was 54 mass %, and a sum thereof was 92 mass %. A glass transition point of the inverse vulcanizate E was 0° C.

### Synthesis Example F

To a glass container, 3.0 g of sulfur was added and stirred at 165° C. for 15 minutes. After it was confirmed that the sulfur was dissolved, 2.0 g of squalene was added, and the mixture was further stirred at 165° C. for 45 minutes. After it was confirmed that a color of the solution was changed, the solution was poured into a silicon mold. Thereafter, the solution was heated in an oven at 140° C. for 16 hours to obtain an inverse vulcanizate F. The obtained inverse vulcanizate F was subjected to elementary analysis. As a result, a carbon content was 31 mass %, a sulfur content was 64 mass %, and a sum thereof was 95 mass %. A glass transition point of the inverse vulcanizate F was 35° C.

### Synthesis Example G

To a glass container, 4.0 g of sulfur was added and stirred at 185° C. for 10 minutes. After it was confirmed that the sulfur was dissolved, 2.5 g of 1,3-diisopropenylbenzene was added, and the mixture was further stirred at 185° C. for 30 minutes to obtain an inverse vulcanizate G. The obtained inverse vulcanizate G was subjected to elementary analysis. As a result, a carbon content was 43 mass %, a sulfur content was 49 mass %, and a sum thereof was 92 mass %. A glass transition point of the inverse vulcanizate G was 25° C.

### Synthesis Example H (Comparative Example)

To a glass container, 4.0 g of sulfur was added and stirred at 165° C. for 15 minutes. After it was confirmed that the sulfur was dissolved, 1.5 g of ethylene glycol dimethacrylate and 1.0 g of dicyclopentadiene were added, and the mixture was further stirred at 165° C. for 30 minutes. After it was confirmed that a color of the solution was changed, the solution was poured into a silicon mold. Thereafter, the solution was heated in an oven at 140° C. for 16 hours to obtain an inverse vulcanizate H. The obtained inverse vulcanizate H was subjected to elementary analysis. As a result, a carbon content was 32 mass %, a sulfur content was 56 mass %, and a sum thereof was 88 mass %.

### Preparation of Rubber Composition

First, compounding ingredients excluding a vulcanizing agent (including an inverse vulcanizate) and a vulcanization accelerator were added to a diene rubber in a first mixing stage in accordance with the formulations (part by mass) illustrated in Table 1 below by using an internal mixer and kneading was performed (discharge temperature=160° C.). Next, the vulcanizing agent and the vulcanization accelerator were added to the obtained kneaded material in a final mixing stage and kneading was performed (discharge temperature=90° C.) to produce a rubber composition. Details of each component in Table 1 are as follows.
SBR: “SBR1502” manufactured by JSR Corporation
NR: RSS #3
Carbon black: “Show Black N330T” manufactured by Cabot Japan Corporation
Zinc oxide: “Zinc Oxide No. 3” manufactured by Mitsui Mining & Smelting Co., Ltd.
Stearic acid: “LUNAC S-20” manufactured by Kao Corporation
Sulfur: “Powdered sulfur” manufactured by Tsurumi Chemical Industry Co., ltd., sulfur content=95 mass %
Inverse vulcanizates A to H: inverse vulcanizates obtained in Synthesis Examples A to H
Vulcanization accelerator: “NOCCELER CZ-G (CZ)” manufactured by Ouchi Shinko Chemical Industrial Co., Ltd.

### Evaluation of Rubber Composition

Each of the obtained rubber compositions was vulcanized at 160° C. under pressure using a metal plate as a mold to prepare a vulcanized rubber sample. At this time, for a vulcanization time, 90% vulcanization time (t90) measured in advance in accordance with JIS K6300-2:2001 was applied to each rubber composition.

The obtained vulcanized rubber sample was subjected to a tensile test in accordance with the following method to evaluate fracture properties.
Tensile strength at break: the tensile strength at break was measured by performing a tensile test in accordance with JIS K6251:2017. A No. 7 dumbbell was used as a test piece. The results of Comparative Example 2 and Examples 1 to 8 were shown by an index obtained by taking a value of Comparative Example 1 as 100, and the result of Example 9 was shown by an index obtained by taking a value of Comparative Example 3 as 100. The larger the index is, the larger the tensile strength at break is, and the more excellent the breaking strength is.
Elongation at break: the elongation at break was measured by performing a tensile test in accordance with JIS K6251:2017. A No. 7 dumbbell was used as a test piece. The results of Comparative Example 2 and Examples 1 to 8 were shown by an index obtained by taking a value of Comparative Example 1 as 100, and the result of Example 9 was shown by an index obtained by taking a value of Comparative Example 3 as 100. The larger the index is, the larger the elongation at break is, and the more excellent the breaking property is.

TABLE 1

| | Comp. | Ex. | Ex. | Ex. | Ex. | Ex. | Ex. | Ex. | Ex. | Comp. | Comp. | Ex. |
|---|---|---|---|---|---|---|---|---|---|---|---|---|
| | Ex. 1 | 1 | 2 | 3 | 4 | 5 | 6 | 7 | 8 | Ex. 2 | Ex. 3 | 9 |
| Formulation | | | | | | | | | | | | |
| (part by mass) | | | | | | | | | | | | |
| SBR | 100 | 100 | 100 | 100 | 100 | 100 | 100 | 100 | 100 | 100 | | |
| NR | | | | | | | | | | | 100 | 100 |
| Carbon black | 30 | 30 | 30 | 30 | 30 | 30 | 30 | 30 | 30 | 30 | 30 | 30 |
| Zinc oxide | 2 | 2 | 2 | 2 | 2 | 2 | 2 | 2 | 2 | 2 | 2 | 2 |
| Stearic acid | 1 | 1 | 1 | 1 | 1 | 1 | 1 | 1 | 1 | 1 | 1 | 1 |
| Sulfur | 2.5 | | 1 | | | | | | | | 2.5 | |
| Inverse | | 5 | 3 | | | | | | | | | |
| vulcanizate A | | | | | | | | | | | | |
| Inverse | | | | 3.1 | | | | | | | | 3.1 |
| vulcanizate B | | | | | | | | | | | | |
| Inverse | | | | | 5 | | | | | | | |
| vulcanizate C | | | | | | | | | | | | |
| Inverse | | | | | | 5 | | | | | | |
| vulcanizate D | | | | | | | | | | | | |
| Inverse | | | | | | | 5 | | | | | |
| vulcanizate E | | | | | | | | | | | | |
| Inverse | | | | | | | | 5 | | | | |
| vulcanizate F | | | | | | | | | | | | |
| Inverse | | | | | | | | | 5 | | | |
| vulcanizate G | | | | | | | | | | | | |
| Inverse | | | | | | | | | | 5 | | |
| vulcanizate H | | | | | | | | | | | | |
| Vulcanization | 1 | 1 | 1 | 1 | 1 | 1 | 1 | 1 | 1 | 1 | 1 | 1 |
| accelerator | | | | | | | | | | | | |
| Evaluation | | | | | | | | | | | | |
| (index) | | | | | | | | | | | | |
| Tensile | 100 | 135 | 120 | 120 | 125 | 135 | 131 | 104 | 128 | 36 | 100 | 102 |
| strength at | | | | | | | | | | | | |
| break | | | | | | | | | | | | |
| Elongation at | 100 | 132 | 105 | 120 | 155 | 139 | 152 | 111 | 145 | 127 | 100 | 100 |
| break | | | | | | | | | | | | |

The results are as shown in Table 1. In Examples 1 to 8 in which the inverse vulcanizates A to G, in which a total content ratio of the carbon element and the sulfur element was 89 mass % or more, were compounded as vulcanizing agents, both the tensile strength at break and the elongation at break were large and the breaking strength was excellent as compared with Comparative Example 1 in which the sulfur was used as a vulcanizing agent. In Example 9, the breaking strength was excellent as compared with Comparative Example 3.

In contrast, in Comparative Example 2 in which the inverse vulcanizate H, in which the total content ratio of the carbon element and the sulfur element was 88 mass %, was compounded, the elongation at break was excellent, but the tensile strength at break was greatly reduced and the breaking strength was poor as compared with Comparative Example 1.

In various numerical ranges described in the specification, upper limit values and lower limit values thereof can be freely combined, and all combinations thereof are described in the present specification as preferable numerical ranges. In addition, the description of the numerical range of “X to Y” means X or more and Y or less.

What is claimed is:

1. A compounding agent for rubber, comprising:
an inverse vulcanizate in which a sum of a content of a carbon element and a content of a sulfur element is 89 mass % or more.

2. The compounding agent for rubber according to claim 1, wherein
the inverse vulcanizate contains, as a raw material, an organic compound having a topological polar surface area of 50 Å² or less and two or more carbon-carbon double bonds.

3. The compounding agent for rubber according to claim 1, wherein
the inverse vulcanizate contains, as a raw material, an organic compound having two or more carbon-carbon double bonds and zero or one heteroatom contained in one molecule.

4. The compounding agent for rubber according to claim 3, wherein
the organic compound has a topological polar surface area of 50 Å² or less.

5. The compounding agent for rubber according to claim 1, wherein
the inverse vulcanizate contains, as a raw material, an organic compound having two or more carbon-carbon double bonds and an aromatic ring, and the content of the carbon element is 20 mass % or more.

6. The compounding agent for rubber according to claim 5, wherein
the organic compound has a topological polar surface area of 50 Å² or less.

7. The compounding agent for rubber according to claim 5, wherein
the organic compound has zero or one heteroatom contained in one molecule.

8. The compounding agent for rubber according to claim 6, wherein
the organic compound has zero or one heteroatom contained in one molecule.

9. A rubber composition comprising: the compounding agent for rubber according to claim 1.

10. A rubber composition comprising: the compounding agent for rubber according to claim 2.

11. A rubber composition comprising: the compounding agent for rubber according to claim 3.

12. A rubber composition comprising: the compounding agent for rubber according to claim 4.

13. A rubber composition comprising: the compounding agent for rubber according to claim 5.

14. A rubber composition comprising: the compounding agent for rubber according to claim 6.

15. A rubber composition comprising: the compounding agent for rubber according to claim 7.

16. A rubber composition comprising: the compounding agent for rubber according to claim 8.

17. A tire produced using the rubber composition according to claim 9.
